(19) United States
(12) Patent Application Publication
(10) Pub. No.: US 2010/0046579 A1
(43) Pub. Date: Feb. 25, 2010

(54) Rechargeable Ear Thermometer

(76) Inventors: Jeff Baker, Orlando, FL (US); Seth Freytag, Windermere, FL (US)

Correspondence Address: Timothy H. Van Dyke;Beusse Wolter Sanks Mora & Maire, P.A., Suite 2500, 390 North Orange Avenue, Orlando, FL, 32801, US

(21) Appl. No.: 12/195,475

(22) Filed: Aug. 21, 2008

(51) Int. Cl. G01K 1/00; H02J 7/00

(52) U.S. Cl. 374/152; 320/137; 374/E01.001

(57) ABSTRACT

A rechargeable ear thermometer which comprises a planar main body, a planar ear probe panel integral with the planar main body, an ear probe extending from the planar ear probe panel, a power source within the planar main body, and a mechanism at bottom of the planar main body for recharging the power source. An angle is formed between the planar main body and the planar ear probe panel to allow a proper approach to an ear of a person with the ear probe, without having the planar main body pushed up against a face of the person while taking a temperature reading of the person.

### FIELD OF THE INVENTION

The present invention relates to a tympanic temperature monitoring system, and more particularly, a rechargeable ear thermometer.

### BACKGROUND

Clinical studies have shown that the ear is an excellent site for taking body temperature because the temperature taken in the ear reflects the body's core temperature. Body temperature is regulated by the hypothalamus, which shares the same blood supply as the tympanic membrane. Changes in core body temperature are usually seen sooner in the tympanic membrane than in other places, such as rectum, mouth or under the arm.

Body temperature is routinely monitored in Clinical settings with infrared ear thermometers which measure the infrared energy emitted from the patient's eardrum in a calibrated length of time. A short tube with a protective sleeve is inserted into the ear, and a shutter is opened to allow radiation from the tympanic membrane to fall on an infrared detector for a period which is typically from 0.1 to 0.3 seconds. The device beeps when data collection is completed and a readout of temperature is produced on a liquid crystal display.

Temperature from the eardrum has been found to be a clinically reliable indicator of body core temperature. The eardrum is located close to the hypothalamus, which is the body's temperature regulator. The membrane itself is thin and almost transparent. The device reliably tracks the temperature inside the membrane, so that the infrared energy the membrane emits gives a good indication of the inside temperature.

U.S. Pat. No. 5,167,235 issued on Dec. 1, 1992, to Seacord et al. teaches a thermometer for measuring the core temperature of a body by measuring infrared radiation emitted by the tympanic membrane of the ear. The thermometer includes a fiber optic fiber bundle assembly which is inserted into the ear canal to a location adjacent to the tympanic membrane. Infrared radiation is conveyed to a thermopile which converts the radiation to an electrical signal. To assure an accurate signal in changing ambient temperature conditions, circuitry is provided which measures the thermopile resistance (heat) just prior and/or just subsequent to taking a temperature reading and nulling this signal. A disposable sheath is provided to cover the end of the fiber optic assembly inserted into the ear canal to prevent cross contamination between patients. The sheath includes an infrared radiation transparent window over the end of the fiber optic so that there are no openings in the sheath within the ear. Electronic circuitry is provided to measure and display input voltage characteristics, compensate for room temperature variations, fiber optic transmission variations and thermopile cold junction temperature variations, and display an accurate measured temperature. The temperature measured is displayed within about one second of initiation of temperature measurement.

U.S. Pat. No. 6,001,066 issued on Dec. 14, 1999, to Canfield et al. teaches a two-piece portable, self-contained tympanic thermometer temperature measuring system that includes a measuring unit and a base unit. The measuring unit can be ergonomically designed as a compact, pencil-shaped, easy to hold unit that includes a removable sensing module that interfaces with the base unit and/or other host via digital signaling. All analog circuitry can be self-contained within the sensor module, and the sensing module circuitry components may be potted with thermally conductive epoxy to reduce variations due to differences in component temperatures. The sensing module casing may be made out of a conductor to provide electromagnetic field isolation. The sensing module can include a microcontroller that communicates with a microcontroller in the base unit via a removable modular 4-conductor telephone handset cord. The measuring unit preferably has the capability to measure the amount of pressure it is applying to the patient's ear-and thus, the ability to sense when it is in position and has sealed the patient's outer ear canal. Temperature measurement can be performed automatically and/or inhibited in response to this pressure sensing.

U.S. Pat. No. 6,435,711 issued on Aug. 20, 2002, to Gerlitz teaches an infrared ear thermometer that includes a detector head housing, a heat sink, a recess formed in the heat sink, a thermopile sensor mounted within the recess, a thermistor, and temperature determination circuitry. The recess defines an aperture that limits the field of view of the thermopile sensor. The thermal capacities and conductivities of the heat sink and the thermopile sensor are selected so that the output signal of the thermopile sensor stabilizes during a temperature measurement. A method of determining temperature using an ear thermometer takes successive measurements, stores the measurements in a moving time window, averages the measurements in the moving window, determines whether the average has stabilized, and outputs an average temperature. A method of calculating a subject's temperature determines the temperature of a cold junction of the thermopile, looks up a bias and slope of the thermopile based upon the temperature of the cold junction, measures the output of the thermopile, and calculates the subject's temperature based upon a linear relationship between the output and the subject's temperature. The linear relationship is defined by the bias and the slope.

U.S. Pat. No. 6,485,433 issued on Nov. 26, 2002, to Peng teaches an ear thermometer having a rotatable and revolvable detector probe. The thermometer includes a thermometer body; a detector probe insertable into an external auditory canal; and a connecting device for rotatably and revolvably connecting the detector probe to the thermometer body. The connecting device includes a pivot journal that fixedly engages the thermometer body and receives a portion of the detector probe in pivotally engaged manner.

It is apparent now that different ear thermometers are present in the prior art that are adequate for various purposes. However, the aforementioned references do not disclose the elements of embodiments of the present invention and fail to contemplate the unique and advantageous aspects of various embodiments of the invention.

### SUMMARY OF THE INVENTION

Certain embodiments of the present invention provide a rechargeable ear thermometer having a USB plug that is inserted into a USB port in a computer to recharge a rechargeable battery and is simple to use.

One embodiment of the present invention provides a rechargeable ear thermometer which comprises a planar main body, a planar ear probe panel integral with the planar main body, an ear probe extending from the planar ear probe panel, a power source within the planar main body, and a mechanism at bottom of the planar main body for recharging the power source. An angle is formed between the planar main body and the planar ear probe panel to allow a proper approach to an ear of a person with the ear probe, without having the planar main body pushed up against a face of the person while taking a temperature reading of the person.

The novel features which are considered characteristics of certain embodiments of the present invention are set forth in the appended claims. Embodiments of the invention relating to construction and method of operation embodiments, together with additional advantages thereof, will be best understood from the following description of the specific embodiments when read and understood in connection with the accompanying drawings.

### BRIEF DESCRIPTION OF THE DRAWINGS

The figures of the drawings are briefly described as follows:

FIG. 1 is a perspective view of an embodiment of the present invention;

FIG. 2 is a front view taken in the direction of arrow 2 in FIG. 1;

FIG. 3 is a side view taken in the direction of arrow 3 in FIG. 1; and

FIG. 4 is a top view taken in the direction of arrow 4 in FIG. 1.

### REFERENCE NUMERALS UTILIZED IN THE DRAWINGS

10 rechargeable ear thermometer
12 planar main body of rechargeable ear thermometer 10
14 planar ear probe panel of rechargeable ear thermometer 10
16 ear probe on planar ear probe panel 14
18 power source in planar main body 12
19 recharging mechanism of rechargeable ear thermometer 10
20 angle between planar main body 12 and planar ear probe panel 14
22 digital display screen on planar ear probe panel 14
24 power/reset button on planar main body 12
26 aluminum casing of planar main body 12 and planar ear probe panel 14
28 snap on plastic face plate of planar main body 12 and planar ear probe panel 14
30 rechargeable battery for power source 18
32 USB plug for recharging mechanism 19
34 retracting and extending mechanism in rechargeable ear thermometer 10
36 slide button for retracting and extending mechanism 34
38 side track in planar main body 12

### DETAILED DESCRIPTION

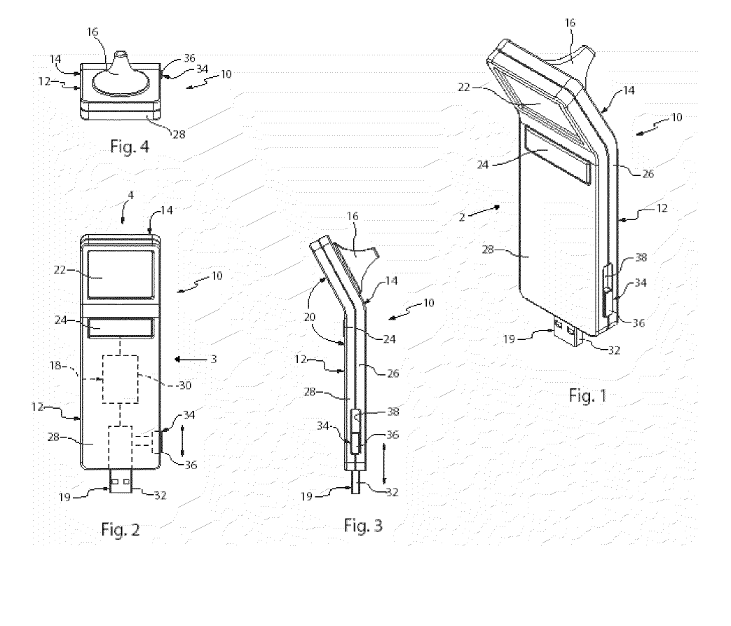

Referring now to the figures, in which like numerals indicate like parts, and particularly to FIGS. 1 through 4, which are a perspective view of an embodiment of the present invention; a front view taken in the direction of arrow 2 in FIG. 1; a front view taken in the direction of arrow 2 in FIG. 1; a side view taken in the direction of arrow 3 in FIG. 1; and a top view taken in the direction of arrow 4 in FIG. 1, and as such, will be discussed with reference thereto.

According to one embodiment, the present invention pertains to a rechargeable ear thermometer 10 which comprises a planar main body 12; a planar ear probe panel 14 integral with the planar main body 12; an ear probe 16 extending from the planar ear probe panel 14; a power source 18 within the planar main body 12; and a mechanism 19 at bottom of the planar main body 12, for recharging the power source 18. An angle 20 (of approximately 100 to 170 degrees) is formed between the planar main body 12 and the planar ear probe panel 14 to allow a proper approach to an ear of a person with the ear probe 16, without having the planar main body 12 pushed up against a face of the person while taking a temperature reading of the person.

A digital display screen 22 is on the planar ear probe panel 14 opposite from the ear probe 16, so that the temperature reading can be viewed therefrom. A power/reset button 24 is on the planar main body 12 below and adjacent to the digital display screen 22.

The planar main body 12 and the planar ear probe panel 14 both comprise an aluminum casing 26, and a snap on plastic face plate 28, so as to gain access to the power source 18. The power source 18 comprises at least one rechargeable battery 30. The recharging mechanism 19 comprises a USB plug 32 that can be inserted into a USB port in a computer to recharge the at least one rechargeable battery 30.

The rechargeable ear thermometer 10, further comprises a mechanism 34 for retracting and extending the USB plug 32 at bottom of the planar main body 12. When the USB plug 32 is in a retracted position the rechargeable ear thermometer 10 can be utilized for taking the temperature reading of the person. When the USB plug 32 is in an extended position, the USB plug 32 can be inserted into the USB port in the computer to recharge the at least one rechargeable battery 30. The retracting and extending mechanism 34 comprises a slide button 36 that rides in a side track 38 in the planar main body 12. The slide button 36 is coupled to one side of the USB plug 32 within the main planar body 12 to move the USB plug 32 between the retracted position and the extended position.

It is apparent in view of the teachings herein that embodiments of the invention are particularly useful for recharging a rechargeable battery within an ear thermometer when a retractable USB plug is extended and inserted into a USB port in a computer.

It will be understood that each of the elements described above, or two or more together, may also find a useful application in other types of constructions differing from the types described above.

While the invention has been illustrated and described as embodiments of a rechargeable ear thermometer, accordingly it is not limited to the details shown, since it will be understood that various omissions, modifications, substitutions and changes in the forms and details the device illustrated and its operation can be made by those skilled in the art without departing in any way from the sprint of the present invention. The teachings of all of the references cited herein are incorporated by reference to the extent not inconsistent with the teachings herein.

1. A rechargeable ear thermometer which comprises:
a) a planar main body;
b) a planar ear probe panel integral with said planar main body;
c) an ear probe extending from said planar ear probe panel;
d) a power source within said planar main body; and
e) means at bottom of said main body, for recharging said power source;
wherein an angle is present between said planar main body and said planar ear probe panel to allow a proper approach to an ear of a person with said ear probe, without having said planar main body pushed up against a face of the person while taking a temperature reading of the person.

2. (canceled)

3. The rechargeable ear thermometer as recite in claim 1, further comprising a digital display screen on said planar ear probe panel opposite from said ear probe, so that the temperature reading can be viewed therefrom.

4. The rechargeable ear thermometer as recited in claim 3, further comprising a power/reset button on said planar main body below and adjacent to said digital display screen.

5. The rechargeable ear thermometer as recited in claim 4, wherein said planar main body and said planar ear probe panel both comprise:
a) an aluminum casing; and
b) a snap on plastic face plate, so as to gain access to said power source.

6. The rechargeable ear thermometer as recited in claim 5, wherein said power source comprises at least one rechargeable battery.

7. The rechargeable ear thermometer as recited in claim 6, wherein said recharging means comprises a USB plug that can be inserted into a USB port in a computer to recharge said at least one rechargeable battery.

8. The rechargeable ear thermometer as recited in claim 7, further comprising means for retracting and extending said USB plug at bottom of said planar main body, whereby when said USB plug is in a retracted position said rechargeable ear thermometer can be utilized for taking the temperature reading of the person, and when said USB plug is in an extended position, said USB plug can be inserted into the USB port in the computer to recharge said at least one rechargeable battery.

9. The rechargeable ear thermometer as recited in claim 8, wherein said retracting and extending means comprises a slide button that rides in a side track in said planar main body, wherein said slide button is coupled to one side of said USB plug within said main planar body to move said USB plug between the retracted position and the extended position.

10. A rechargeable ear thermometer which comprises:
a planar main body;
a planar ear probe panel integral with said planar main body;
an ear probe extending from said planar ear probe panel;
a power source within said planar main body; and
a usb plug at bottom of said main body, for recharging said power source;
wherein an angle is formed between said planar main body and said planar ear probe panel to allow a proper approach to an ear of a person with said ear probe, without having said planar main body pushed up against a face of the person while taking a temperature reading of the person.

11. The rechargeable ear thermometer of claim 10, wherein said usb plug extends out of and retracts into said main body.
